(19) United States
(12) Patent Application Publication
(10) Pub. No.: US 2014/0068424 A1
(43) Pub. Date: Mar. 6, 2014

(54) GESTURE-BASED NAVIGATION USING VISUAL PAGE INDICATORS

(71) Applicants: Adil Dhanani, Mountain View, CA (US); Angela I. Tam, San Francisco, CA (US)

(72) Inventors: Adil Dhanani, Mountain View, CA (US); Angela I. Tam, San Francisco, CA (US)

(21) Appl. No.: 13/600,340

(22) Filed: Aug. 31, 2012

(51) Int. Cl. G06F 3/041; G06F 17/00

(52) U.S. Cl. 715/251

(57) ABSTRACT

Example embodiments relate to gesture-based navigation using visual page indicators. In example embodiments, a computing device detects a held user input and a movement of the held input in a first direction. In response to the held input exceeding a movement threshold in the first direction, the device may display a visual indicator that indicates that a currently-displayed user interface will change from a current page to a second page in response to a release of the held input. The device may then modify the currently-displayed interface from the current page to the second page in response to the release of the held input while the visual indicator is displayed.

### BACKGROUND

With the increasing processing power, storage capability, and display quality of electronic devices, many users rely on such devices to consume significant amounts of digital content. For example, many users now utilize mobile phones, e-readers, tablets, and personal computers to execute applications for accessing web pages, electronic books, portable document format (PDF) files, and other digital content. Electronic devices currently provide a number of mechanisms for navigating between pages within these applications.

### BRIEF DESCRIPTION OF THE DRAWINGS

The following detailed description references the drawings, wherein:

FIG. 1 is a block diagram of an example computing device for enabling gesture-based navigation between pages in a user interface using visual page indicators;

FIG. 2 is a block diagram of an example computing device for enabling gesture-based navigation between pages in a user interface using a plurality of icons and corresponding visual features;

FIG. 3 is a flowchart of an example method for enabling gesture-based navigation between pages in a user interface using visual page indicators;

FIG. 4 is a flowchart of an example method for enabling gesture-based navigation between pages in a user interface based on the direction and magnitude of the movement of a user's held input;

FIG. 5A is a diagram of an example user interface of a web browser in an initial state;

FIG. 5B is a diagram of an example user interface of a web browser in which a panel including navigation icons has been displayed in response to movement of a user's held touch to the right;

FIG. 5C is a diagram of an example user interface of a web browser in which a visual feature has highlighted a previous page in response to further movement of the user's held touch to the right;

FIG. 5D is a diagram of an example user interface of a web browser in which the browser has changed the interface to a previous page in response to a release of the user's held touch;

FIG. 6 is a diagram of an example user interface of a web browser in which a panel including navigation icons has been displayed, the icons corresponding to a current page, a previous page, and a home page;

FIG. 7 is a diagram of an example user interface of a web browser in which a panel including navigation icons has been displayed in response to movement of a user's held touch to the left; and

FIG. 8 is a diagram of an example user interface of a web browser in which a panel including navigation icons has been displayed in response to movement of a user's held touch to the right, the icons including a plurality of icons corresponding to previous pages.

### DETAILED DESCRIPTION

As detailed above, electronic devices currently provide a number of mechanisms for enabling a user to navigate between pages within an application. For example, a typical web browser provides back and forward buttons that allow the user to navigate within the page viewing history for a particular session of the browser. Button-based navigation is generally inefficient, as it requires that the user activate a particular button that occupies a relatively small portion of the user interface.

As another example, many electronic book applications enable a user to move between pages using a gesture, such as a flick left or right using a mouse movement or touch on a touch-enabled display. Some web browsers include similar functionality, such that a user may navigate backward and forward using gestures with one or more fingers. One problem with gesture-based navigation is that it may lack discoverability, as it generally does not provide visible guidance to the user while the gesture is inputted. For example, gesture-based navigation typically does not allow the user to easily identify the previous or subsequent page during the gesture without actually going to that page. In addition, gesture-based navigation generally only allows a user to move backward or forward one page at a time.

Example embodiments disclosed herein address these problems with existing methods by providing for gesture-based navigation using visual page indicators. In example embodiments, a computing device detects a held user input, such as a touch or mouse click, and movement of the input in a first direction (e.g., left or right). In response to the held input exceeding a movement threshold in the first direction, the device may then display a visual indicator that indicates that a currently-displayed user interface will change from a current page to a second page in response to a release of the held input. When the user releases the held input while the visual indicator is still displayed, the device may modify the currently-displayed interface from the current page to the second page.

In this manner, example embodiments disclosed herein enable efficient, intuitive navigation between pages within an application. In particular, example embodiments enable a user to navigate between pages with a held gesture that triggers display of a visual indicator, thereby adding discoverability to the gesture. These embodiments also enable quick selection of a page since the user may easily select the page for display by simply dragging and releasing the input. In addition, some implementations enable a user to move forward or backward multiple pages or to return to a home page with a single gesture.

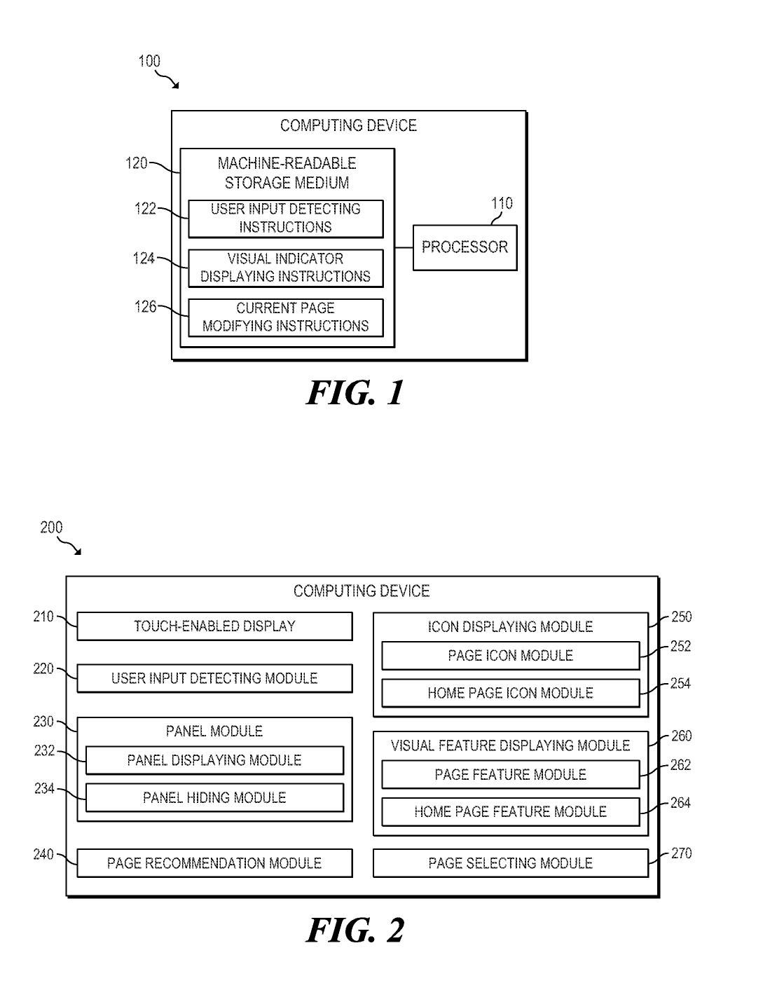

Referring now to the drawings, FIG. 1 is a block diagram of an example computing device 100 for enabling gesture-based navigation between pages in a user interface using visual page indicators. Computing device 100 may be, for example, a notebook computer, a desktop computer, an all-in-one system, a tablet computing device, a mobile phone, an electronic book reader, or any other electronic device suitable for displaying a user interface and processing user interactions with the displayed interface. In the embodiment of FIG. 1, computing device 100 includes a processor 110 and a machine-readable storage medium 120.

Processor 110 may be one or more central processing units (CPUs), semiconductor-based microprocessors, and/or other hardware devices suitable for retrieval and execution of instructions stored in machine-readable storage medium 120. Processor 110 may fetch, decode, and execute instructions 122, 124, 126 to control the process for gesture-based navigation. As an alternative or in addition to retrieving and executing instructions, processor 110 may include one or more electronic circuits that include electronic components for performing the functionality of one or more of instructions 122, 124, 126.

Machine-readable storage medium 120 may be any electronic, magnetic, optical, or other physical storage device that contains or stores executable instructions. Thus, machine-readable storage medium 120 may be, for example, Random Access Memory (RAM), an Electrically Erasable Programmable Read-Only Memory (EEPROM), a storage device, an optical disc, and the like. In some implementations, storage medium 120 may be a non-transitory storage medium, where the term “non-transitory” does not encompass transitory propagating signals. As described in detail below, machine-readable storage medium 120 may be encoded with a series of executable instructions 122, 124, 126 for detecting a user's held input, displaying a visual indicator in response to movement of the held input, and modifying a currently-displayed page in response to a release of the held input.

Computing device 100 may initially output a user interface for an application that displays a number of pages and allows the user to navigate between the pages. The application may be, for example, an electronic book reader, a PDF viewer, a word processing application, a web browser, a multimedia player, or any other application that displays a series of pages. Thus, the term “page” should be understood to encompass any user interface that represents content suitable for display by the application. For example, each page may be a section of written content in a word processing or PDF file, an interface representing a particular multimedia file, or a web page displayed within a web browser.

Computing device 100 may output the user interface on an available display, which in some cases may be a touch-enabled display. After output of the user interface, user input detecting instructions 122 may then begin detecting and processing input from the user. For example, detecting instructions 122 may receive user input in the form of a touch gesture on a touch-enabled display, track pad, or similar input mechanism. As another example, detecting instructions 122 may receive input as a click of a mouse button coupled with movement of the mouse.

After receiving user input, detecting instructions 122 may then monitor for a held user input that indicates a desire to change the currently-displayed page. The held input may be any input in which the user activates an input device and continues to hold the input for a period of time, such as a touch input or mouse click. Upon detection of the held input, input detecting instructions 122 may begin monitoring movement of the held touch. Input detecting instructions 122 may then provide details regarding the input to visual indicator displaying instructions 124, such as the initial position of the input and the current location of the input.

In response to receipt of details regarding a user's held input, visual indicator displaying instructions 124 may determine whether the input has exceeded a movement threshold in a direction that corresponds to a change of the currently-displayed page. In some implementations, horizontal movements may be assigned to the page change command, such that movement from left to right corresponds to a command to move to the previous page, while movement from right to left corresponds to a command to move to the next page. Visual indicator displaying instructions 124 may next determine the distance the user has moved the held input as, for example, a percentage of the page width and determine whether this distance is greater than a given set of threshold values. A similar methodology may be applied to vertical movements on the interface, such that the movements are up/down and the thresholds are determined with respect to the page height.

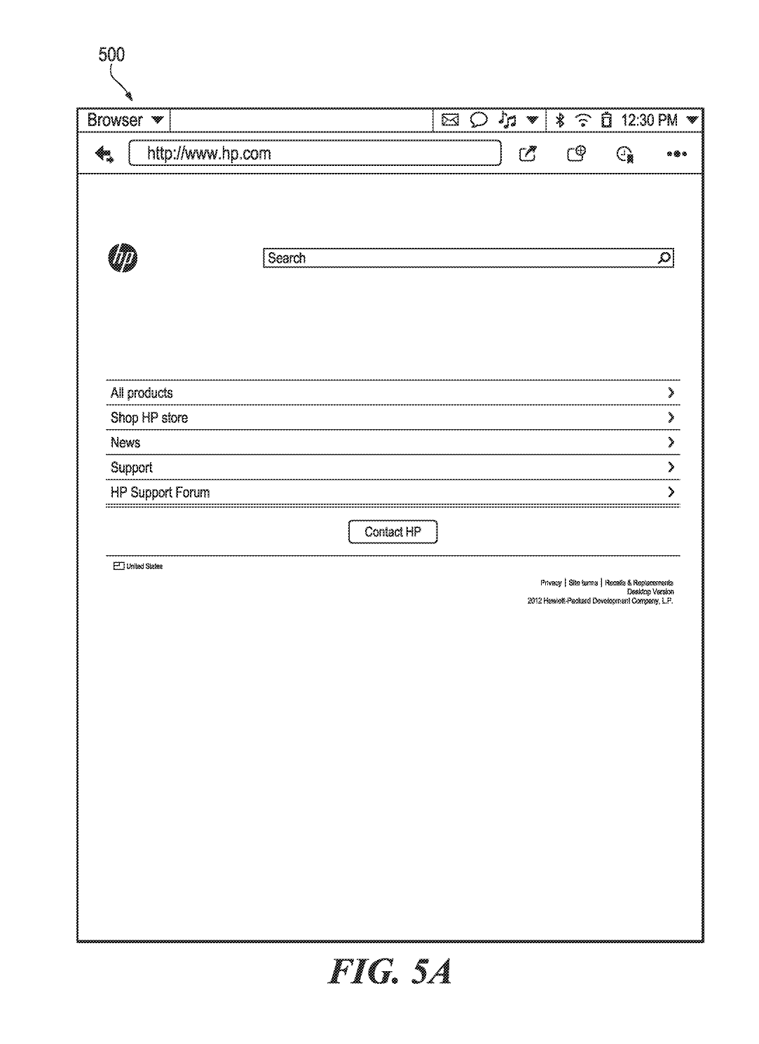

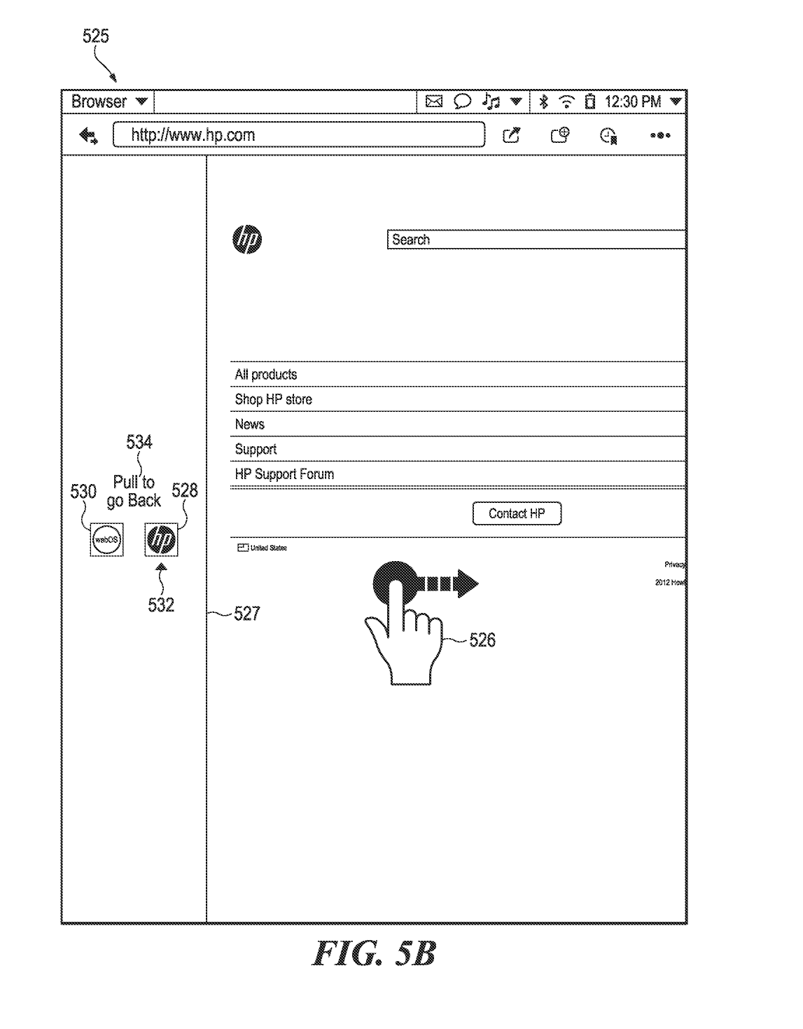

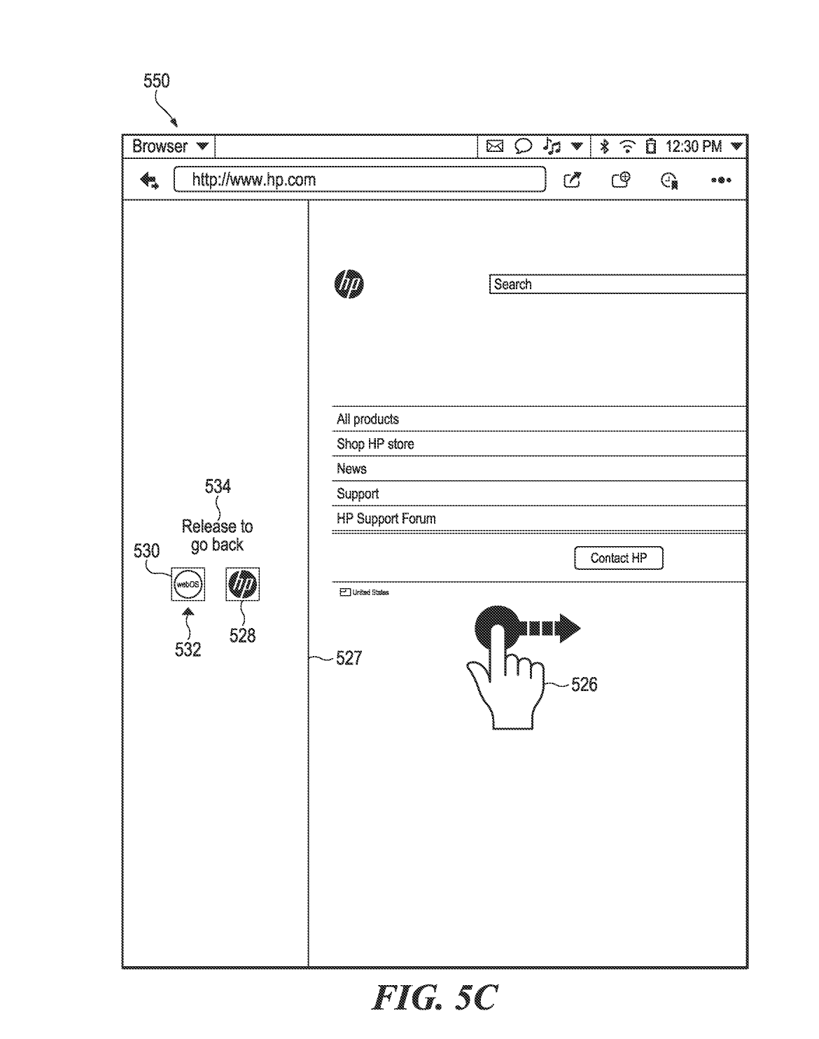

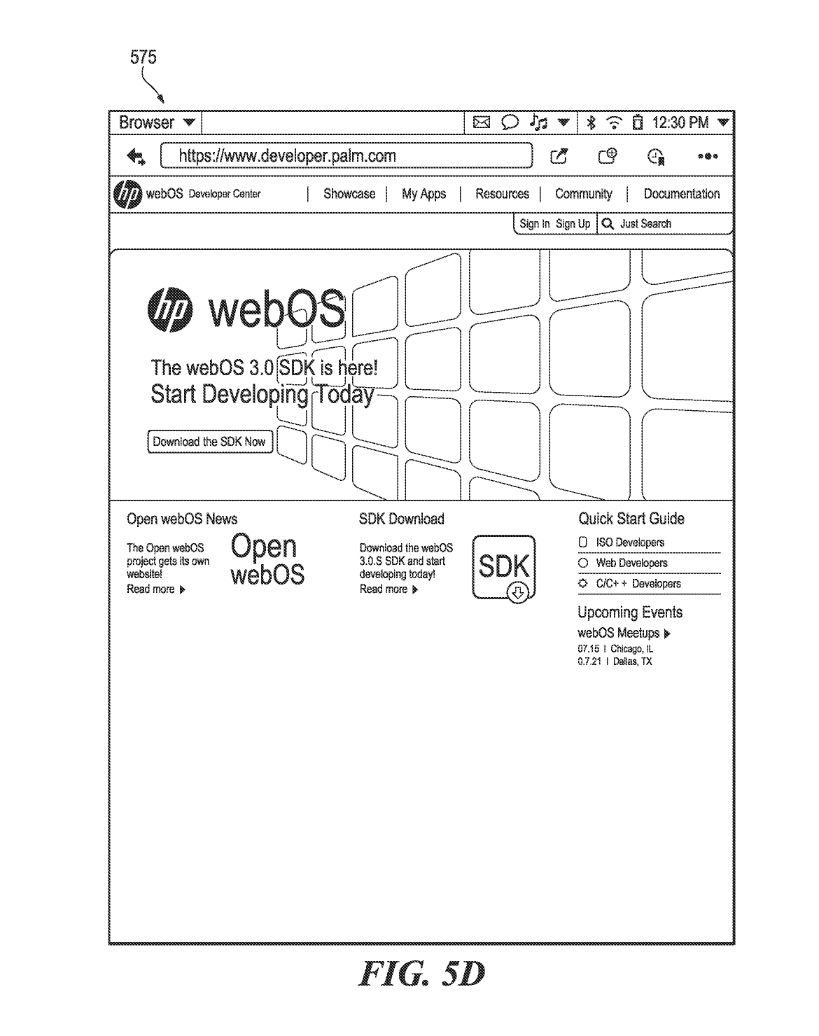

When the distance of the held input has exceeded an initial threshold value, visual indicator displaying instructions 124 may then display a visual indicator that provides a visual cue regarding a page change. For example, displaying instructions 124 may display an initial visual indicator specifying that the page change operation has been initiated in response to the distance of the held input exceeding 25% of the page width. The initial visual indicator may include an icon corresponding to the currently-displayed page and a visual feature that emphasizes the current page as being selected. The visual indicator may also include a text prompt providing instructions to the user regarding the command. As a specific example, referring to FIG. 5B, an HP icon 528 that corresponds to the current webpage is displayed along with an arrow 532 indicating that the HP page is currently selected, while a text label 534 (“Pull to go back”) provides instructions to the user.

As the user continues to drag the held input, visual indicator displaying instructions 124 may output additional visual indicators depending on the direction of the movement of the held input. For example, displaying instructions 124 may output a visual indicator corresponding to a previous page when the movement is from left to right and exceeds 35% of the page width. The previous page may be a page that is numerically prior to the current page, a page prior to the current page in a browser's navigation history, etc. Similarly, displaying instructions 124 may output a visual indicator corresponding to a subsequent page when the movement is from right to left and exceeds 35% of the page width. The subsequent page may be a page that is numerically subsequent to the current page, a page after the current page in a browser's navigation history, etc.

As mentioned above, the visual indicator for each page may include an icon corresponding to the page, a visual feature emphasizing that the page will change if the input is released (e.g., an arrow), and a text prompt providing instructions to the user (e.g., “Release to change page”). As a specific example; referring to FIG. 5C, a webOS icon 530 that corresponds to a previous webpage is displayed along with an arrow 532 indicating that the browser will change to the webOS page if the input is released.

Note that the icons displayed by visual indicator displaying instructions 124 may be any representations of the corresponding page. For example, each icon may be a thumbnail image of the page content, a favicon, a textual description, a page number, or any other visible feature that identifies the page. Similarly, the visual features may be any visible elements that emphasize a particular page as currently selected. For example, each visual feature may be an arrow, a circle or rectangle, a color change, or any other visible feature that indicates to the user that a given icon is currently selected.

When the held input is released while the visual indicator is displayed, current page modifying instructions 126 may then modify the currently-displayed interface to the page corresponding to the visual indicator. For example, when the movement is left to right and the indicator therefore corresponds to a previous page, modifying instructions 126 may change the page to the previous page when the user releases the held touch. Similarly, when the movement is right to left and the indicator therefore corresponds to a subsequent page, modifying instructions 126 may change the page to the subsequent page when the user releases the held touch.

Note that, in some instances, releasing the held input does not result in a page change. For example, when the user has released the held input while the visual indicator corresponds to the current page, modifying instructions 126 may simply hide the visual indicator and continue to display the current page within the user interface.

FIG. 2 is a block diagram of an example computing device 200 for enabling gesture-based navigation between pages in a user interface using a plurality of icons and corresponding visual features. As with computing device 100 of FIG. 1, computing device 200 may be any electronic device suitable for displaying a user interface and processing user interactions with the displayed interface.

Touch-enabled display 210 may be any combination of hardware components capable of outputting a video signal and receiving user input in the form of touch. Thus, touch-enabled display 210 may include components of a Liquid Crystal Display (LCD), Light Emitting Diode (LED) display, or other display technology for outputting a video signal received from a processor or another component of computing device 200. In addition, touch-enabled display 210 may include components for detecting touch, such as the components of a resistive, capacitive, surface acoustic wave, infrared, optical imaging, dispersive signal sensing, or in-cell system.

As illustrated in FIG. 2 and described in detail below, computing device 200 may also include a number of modules 220-270. Each of the modules may include a series of instructions encoded on a machine-readable storage medium and executable by a processor of computing device 200. In addition or as an alternative, each module 220-270 may include one or more hardware devices comprising electronic circuitry for implementing the functionality described below.

User input detecting module 220 may monitor user input provided to a user interface of a page-displaying application, such as a web browser, e-book reader, multimedia player, or PDF viewer. In particular, detecting module 220 may monitor for a held user input and movement of the input that together indicate a desire to change the currently-displayed page. In addition, detecting module 220 may also monitor for the release of the held input. Detecting module 220 may provide data regarding the input to modules 230, 240, 250, 260, 270 for processing in displaying visual indicators regarding a page change operation. Additional details regarding user input detecting module 220 are provided above in connection with user input detecting instructions 122 of FIG. 1.

Panel module 230 may be responsible for controlling the display of a panel that includes the visual indicators relating to the page change. Panel displaying module 232 may initially bring a panel into view when the user starts to move a held touch. In particular, when detecting module 220 detects a held touch and corresponding movement of the held touch, panel displaying module 234 may begin to bring the panel into view from an edge of the screen. For example, when the movement of the held touch is left to right, panel displaying module 234 may begin to bring the panel into view from the left edge of the user interface. Conversely, when the movement of the held touch is from right to left, panel displaying module 234 may begin to bring the panel into view from the right edge of the user interface. In this manner, panel displaying module 234 may gradually move the panel into view as the held user input is moved. FIGS. 5B, 5C, 6, 7, and 8, described in detail below, each illustrate a panel that includes the visual indicators.

Panel hiding module 234 may control the process for hiding a panel upon a release of the held input by the user. In some instances, panel hiding module 234 may gradually move the panel out of view in the opposite direction it was originally brought into view. Thus, when the user releases a held touch that was moved from left to right, panel hiding module 234 may gradually shrink in size toward the left edge of the user interface. Conversely, when the user releases a held touch that was moved from right to left, panel hiding module 234 may gradually shrink in size toward the right edge of the user interface.

Page recommendation module 240 may select pages to recommend to the user based on the currently-displayed page. For example, when the application is a web browser, page recommendation module 240 may determine the uniform resource locator (URL) of the current page and select one or more additional websites that are likely to be of interest based on the current page. As one example, the browser may send the URL of the current page to a search engine or other web service that recommends similar webpages. As another example, page recommendation module 240 may perform local analysis to identify bookmarked webpages most similar to the current page. Regardless of the method used to select recommended pages, icon displaying module 250 may present icons corresponding to the recommended pages for selection using the held touch gesture.

Icon displaying module 250 may manage the process for displaying an icon for each of a plurality of pages within the panel displayed by panel module 230. Page icon module 252 may initially identify an icon for the current page (e.g., a thumbnail image, favicon, etc.) and output the icon within the panel. Page icon module 252 may then select one or more additional icons for display based on the direction of the movement of the held input. For example, when the movement of the held input is left to right, module 252 may determine that the user desires to navigate to previous pages and therefore output icons for one or more pages prior to the current page. Alternatively, when the movement of the held input is right to left, module 252 may determine that the user desires to navigate to subsequent pages and therefore output icons for one or more pages after the current page.

In some implementations, page icon module 252 may in addition or instead display icons for recommended pages selected by page recommendation module 240. For example, instead of or in addition to the icons corresponding to the previous or subsequent pages, page icon module 252 may display icons corresponding to pages that are likely to be of interest to the user based on the current page.

Home page icon module 254 may similarly display an icon that corresponds to a home page within the panel displayed by panel module 230. The home page may be any page to which the user is likely to want to return on a regular basis, such as a browser home page or a table of contents of an electronic book or PDF file. The home page icon may indicate that the currently-displayed interface will change from the current page to the home page when the user releases a held touch while a corresponding visual feature is displayed by home page feature module 264. As with the icons for other pages, the home page icon may be a thumbnail image, a favicon, a symbol (e.g., a picture of a house), or any other visual element that identifies the home page.

Visual feature displaying module 260 may handle the process for indicating which of the icons outputted by icon displaying module 250 is currently selected based on the user's held touch. In particular, page feature module 262 may output the visual feature for the subsequent, previous, and recommended page icons, while home page feature module 264 may output the visual feature for the home page icon. As indicated above, each visual feature may be any visible element that emphasizes a particular icon as currently selected; such as an arrow, circle or rectangle surrounding the icon, or color change.

In some implementations, the icon for which the visual feature is displayed may be selected depending on a range of movement thresholds specified with respect to the held input. For example, when the held input exceeds an initial movement threshold in a given direction (e.g., 25% of the page width), page feature module 262 may emphasize the icon corresponding to the current page. When the held input is moved further such that it exceeds a next threshold (e.g., 35% of the page width), page feature module 262 may emphasize the icon corresponding to the immediately previous or subsequent page. As the user continues to move the held input, page feature module 262 may then progressively move the visual feature to correspond to other previous or subsequent pages (e.g., the current page plus or minus 2, the current page plus or minus 3, etc.). Finally, when the held input exceeds a movement threshold corresponding to a home page icon (e.g., 50% of the page width), home page feature module 264 may move the visual feature such that it emphasizes the home page icon.

Page selecting module 270 may control the process for changing the current page in response to a release of the held touch. In particular, upon release of the held touch, page selecting module. 270 may first identify the icon that is currently emphasized by the visual feature. Page selecting module 270 may then modify the currently-displayed interface from the current page to the selected page. For example, when the visual feature corresponds to the current page, page selecting module 270 may maintain the display of the current page. Alternatively, when the visual feature corresponds to a previous page, subsequent page, recommended page, or home page, page selecting module 270 may change the display to the selected page. In addition, upon release of the held touch, panel hiding module 234 may hide the panel, icon displaying module 250 may hide the displayed icons, and visual feature displaying module 260 may hide the displayed visual feature.

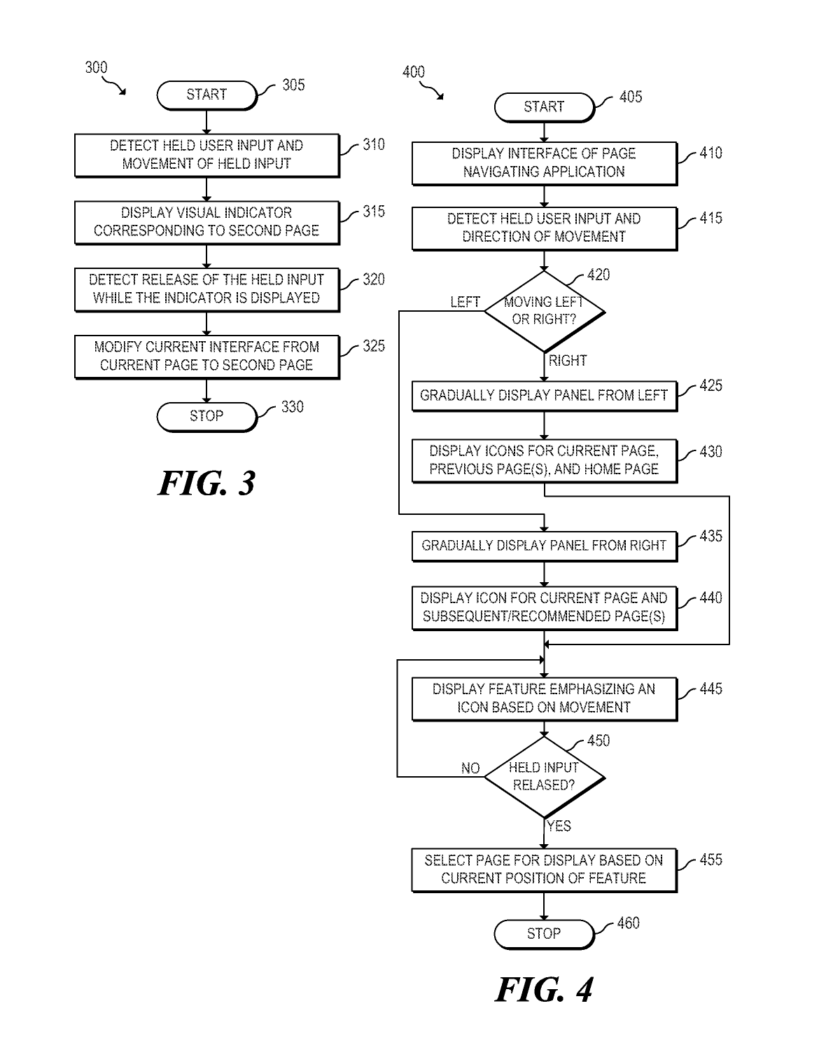

FIG. 3 is a flowchart of an example method 300 for enabling gesture-based navigation between pages in a user interface using visual page indicators. Although execution of method 300 is described below with reference to computing device 100 of FIG. 1, other suitable devices for execution of method 300 will be apparent to those of skill in the art (e.g., computing device 200). Method 300 may be implemented in the form of executable instructions stored on a machine-readable storage medium, such as storage medium 120, and/or in the form of electronic circuitry.

Method 300 may start in block 305 and proceed to block 310, where computing device 100 may detect a held user input and subsequent movement of the held user input. For example, computing device 100 may detect a held touch or mouse click followed by movement of the held input in a given direction (e.g. left/right or up/down).

Next, in block 315, computing device 100 may display a visual indicator corresponding to a second page, which may be, for example, a page previous or subsequent to the current page. In addition, the visual indicator may include an icon representing the page and a visual feature emphasizing the icon as currently selected based on the position of the held touch.

In block 320, computing device 100 may detect a release of the held input while the indicator is displayed for the second page. Finally, in block 325, computing device 325 may modify the current interface of the application, such that the displayed page changes from the current page to the second page. Method 300 may then stop in block 330.

FIG. 4 is a flowchart of an example method 400 for enabling gesture-based navigation between pages in a user interface based on the direction and magnitude of the movement of a user's held input. Although execution of method 400 is described below with reference to computing device 200 of FIG. 2, other suitable devices for execution of method 400 will be apparent to those of skill in the art. Method 400 may be implemented in the form of executable instructions stored on a machine-readable storage medium and/or in the form of electronic circuitry.

Method 400 may start in block 405 and proceed to block 410, where computing device 200 may output a user interface of a page navigation application, such as a web browser, an e-book reader, a PDF viewer, or a word processing application.

In block 415, computing device 200 may then detect a held user input initiated within the page navigation application. Computing device 200 may also determine the direction of movement of the held input. In block 420, computing device 200 may then determine whether the held user input is moving left or right.

When computing device 200 determines that the held user input is moving to the right, method 400 may proceed to block 425. In block 425, computing device 200 may gradually begin to display a panel from the left side of the user interface. For example, the panel may gradually move into view as the user continues to move the held input to the right. In block 430, computing device 200 may then output a series of icons within the displayed panel. For example, computing device 200 may display an icon for the current page, one or more previous page(s), and/or a home page of the application. Method 400 may then proceed to block 445, described in detail below.

Alternatively, when computing device 200 determines in block 420 that the held user input is moving to the left, method 400 may proceed to block 435. In block 435, computing device 200 may gradually begin to display a panel from the right side of the user interface. For example, the panel may gradually move into view as the user continues to move the held input to the left. In block 440, computing device 200 may display an icon for the current page, one or more subsequent page(s), and/or one or more recommended pages. Method 400 may then proceed to block 445.

In block 445, computing device 200 may then display a visual feature emphasizing a particular icon based on the movement of the held input. For example, computing device 200 may emphasize a particular icon based on the distance the user has moved the held touch as a percentage of the page width. Thus, at a first movement threshold (e.g., 25% of the width), computing device 200 may emphasize the icon corresponding to the current page. At a second movement threshold (e.g., 35% of the width), computing device 200 may emphasize the icon corresponding to a previous or subsequent/recommended page. When the held touch is moving to the left, computing device 200 may also emphasize the home icon when the held touch reaches a third movement threshold (e.g., 50% of the width).

In block 450, computing device 200 may determine whether the user has released the held input. If the user has not yet released the input, method 400 may return to block 445, where computing device 200 may continue to update the emphasized icon based on the movement of the held input. Alternatively, when the user has released the held input, method 400 may continue to block 455.

In block 455, computing device 200 may select the page for display in the page navigating application based on the current position of the displayed visual feature. For example, computing device 200 may continue to display the current page when the visual feature is emphasizing the current page. Alternatively, computing device 200 may change the page to a previous, subsequent, recommended, or home page depending on which page is currently emphasized by the visual feature. After maintaining or modifying the displayed page, method 400 may continue to block 460, where method 400 may stop.

FIG. 5A is a diagram of an example user interface 500 of a web browser in an initial state. As illustrated, the web browser is currently displaying a website in the main window of the browser. In this state, the web browser is ready to receive user input in the form of a touch, click, or other input.

FIG. 5B is a diagram of an example user interface 525 of a web browser in which a panel 527 including navigation icons 528, 530 has been displayed in response to movement of a user's held touch to the right. As depicted, the user has activated a touch input and moved his or her hand 526 to the right.

In response, the web browser has displayed a panel 527 on the left side of interface 525. The web browser has also outputted an icon 528 corresponding to the current page and an icon 530 corresponding to a previous page. Because the distance of the held touch has exceeded a first movement threshold (e.g., 25% of the page width), the web browser has outputted a visual feature 532. The visual feature 532, an arrow, emphasizes icon 528, thereby indicating that the web browser will continue to display the current page if the held touch is released. The web browser has also outputted a text prompt 534 instructing the user that he or she should continue to pull the held touch in order to move back to the previous page corresponding to icon 530.

FIG. 5C is a diagram of an example user interface 550 of a web browser in which a visual feature 532 has highlighted a previous page in response to further movement of the user's held touch to the right. In particular, the user has continued to move his or her hand 526 to the right, such that the distance of the held touch has exceeded a movement threshold corresponding to the previous page (e.g., 35% of the page width). In response, the web browser has moved visual feature 532, such that it now emphasizes icon 530. In addition, the web browser has modified text prompt 534 to instruct the user that a release of the held touch will cause the browser to display the page corresponding to icon 530.

FIG. 5D is a diagram of an example user interface 575 of a web browser in which the browser has changed the interface to a previous page in response to a release of the user's held touch. In particular, in response to a release of the held touch while visual feature 532 corresponds to icon 530 (shown in FIG. 5C), the web browser has returned to the previous page in the browser history. The web browser has also hidden panel 527, icon 528, icon 530, visual feature 532, and text prompt 534.

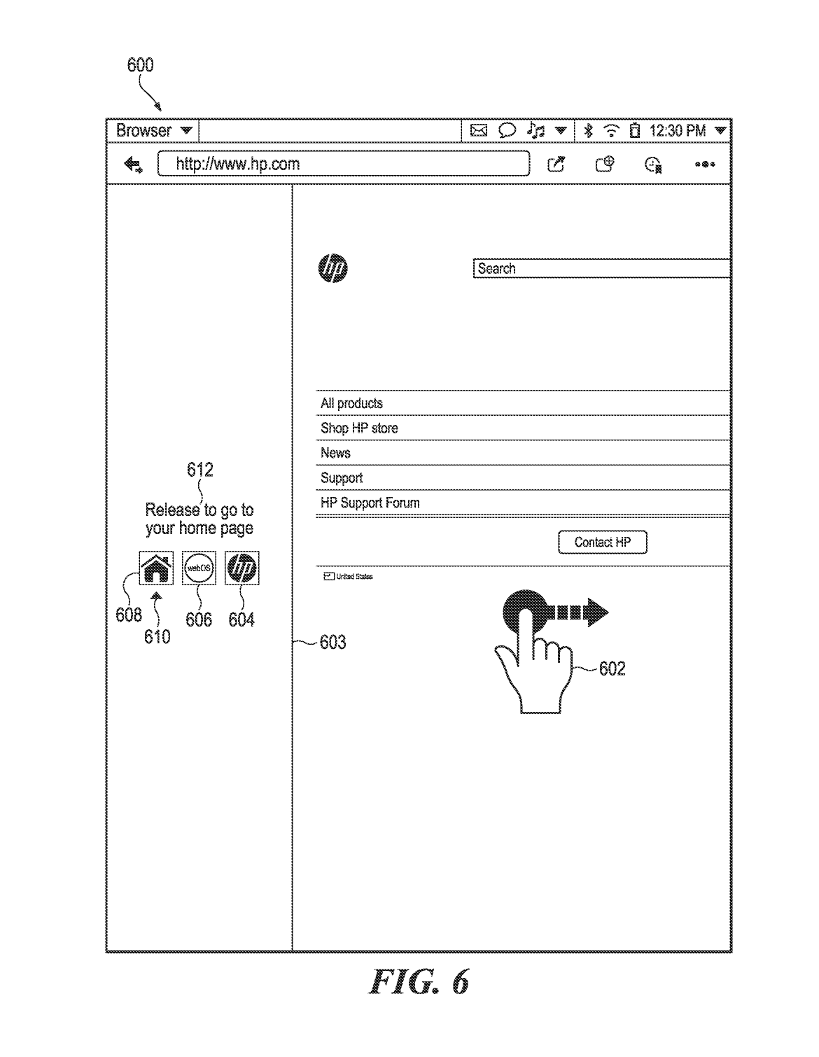

FIG. 6 is a diagram of an example user interface 600 of a web browser in which a panel 603 including navigation icons 604, 606, 608 has been displayed, the icons corresponding to a current page, a previous page, and a home page. As illustrated, the user has activated a touch input and moved his or her hand 602 in a rightward direction.

In response, the web browser has displayed a panel 603 on the left side of interface 600. The web browser has also outputted an icon 604 corresponding to the current page, an icon 606 corresponding to a previous page, and an icon 608 corresponding to the browser's home page. Because the distance of the held touch has exceeded a movement threshold corresponding to the home page (e.g., 50% of the page width), the web browser has outputted a visual feature 610 that emphasizes the home page icon 608 as currently selected. The web browser has also outputted text prompt 612, which instructs the user that a release of the held touch will cause the web browser to return to the home page.

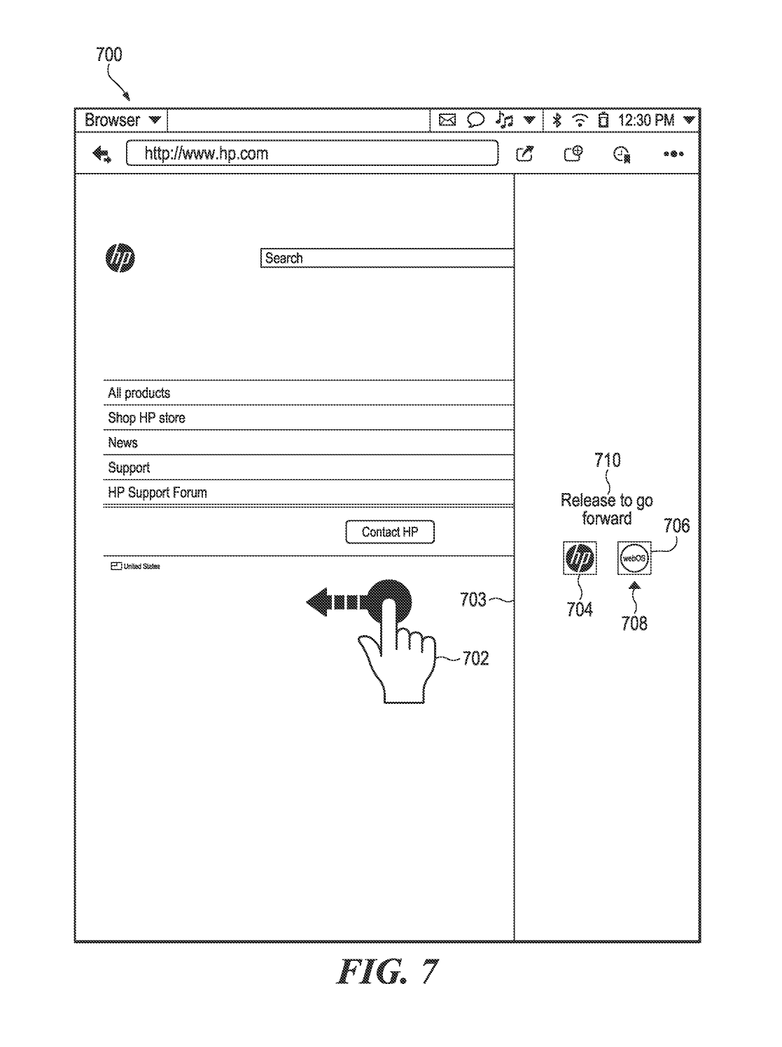

FIG. 7 is a diagram of an example user interface 700 of a web browse which a panel 703 including navigation icons 704, 706 has been displayed in response to movement of a user's held touch to the left. As depicted, the user has activated a touch input and moved his or her hand 702 to the left.

In response, the web browser has displayed a panel 703 on the right side of interface 700. The web browser has also outputted an icon 704 corresponding to the current page and an icon 706 corresponding to a page subsequent to the current page in the browser's history for the session. Note that icon 706 may in some implementations correspond to a recommended page selected for the user based on the currently-displayed page. Because the distance of the held touch has exceeded a movement threshold corresponding to the next page (e.g., 35% of the page width), the web browser has outputted a visual feature 708 emphasizing icon 706. The web browser has also outputted text prompt 710, which instructs the user that a release of the held touch will cause the web browser to move forward in the browser history to the page corresponding to icon 706.

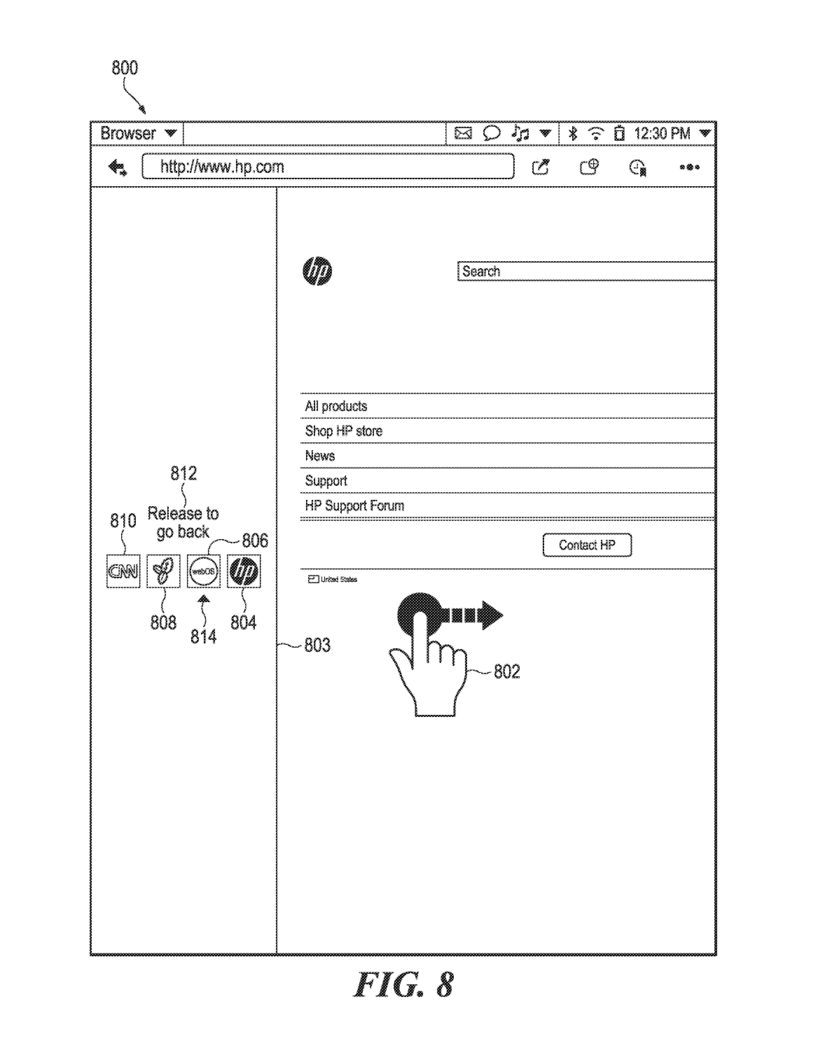

FIG. 8 is a diagram of an example user interface 800 of a web browser in which a panel 803 including navigation icons 804, 806, 808, 810 has been displayed in response to movement of a user's held touch to the right, the icons including a plurality of icons corresponding to previous pages. As depicted, the user has activated a touch input and moved his or her hand 802 to the right.

In response, the web browser has displayed a panel 803 on the left side of interface 800. The web browser has also outputted an icon 804 corresponding to the current page. In addition, the web browser has outputted a series of icons 806, 808, 810 corresponding to consecutive pages previously accessed by the user within the current session of the browser. Because the distance of the held touch has exceeded a movement threshold corresponding to the first of the previously accessed pages (e.g., 35% of the page width), the web browser has outputted a visual feature 814 emphasizing icon 806 and a corresponding text prompt 812. As the user moves the held touch further to the right, the visual feature 814 may be progressively moved to emphasize icon 808 and then icon 810. As with the implementations described above, releasing the held touch will cause the web browser to move backward in the browser history to the page corresponding to the emphasized icon.

The foregoing disclosure describes a number of example embodiments for improved navigation between pages within an application. As detailed above, example embodiments provide an intuitive, discoverable mechanism for allowing a user to move between pages using a simple gesture. Additional embodiments and advantages of such embodiments will be apparent to those of skill in the art upon reading and understanding the foregoing description.

We claim:

1. A computing device for gesture-based page navigation, the computing device comprising:
a processor to:
detect a held user input and a movement of the held input in a first direction;
display a visual indicator that indicates that a currently-displayed user interface will change from a current page to a second page in response to a release of the held input, wherein the indicator appears when the held input exceeds a first movement threshold in the first direction; and
modify the currently-displayed interface from the current page to the second page in response to the release of the held input while the visual indicator is displayed.

2. The computing device of claim 1, wherein the processor is further configured to:
display a panel within the currently-displayed user interface, the panel comprising the visual indicator; and
hide the panel in response to the release of the held touch.

3. The computing device of claim 2, wherein the panel gradually moves into view from an edge of the user interface as the held input is moved in the first direction.

4. The computing device of claim 1, wherein the processor is further configured to;
display a current page visual indicator that indicates that the current page is currently selected in response to the held input exceeding a second movement threshold in the first direction, wherein the second movement threshold is less than the first movement threshold.

5. The computing device of claim 1, wherein the processor is further configured to:
display a home page indicator that indicates that the currently-displayed user interface will change from the current page to a home page in response to the release of the held input, wherein the home page indicator is displayed when the held input exceeds a second movement threshold in the first direction that is greater than the first movement threshold.

6. The computing device of claim 5, wherein each movement threshold is defined as a predetermined percentage of a dimension of the user interface in the first direction.

7. The computing device of claim 1, wherein:
the second page is a page prior to the current page when the first direction is from left to right in the user interface; and
the second page is a page subsequent to the current page when the first direction is from right to left in the user interface.

8. The computing device of claim 1, wherein the displayed visual indicator comprises an icon representing the previous page and a visual feature that emphasizes the icon as currently selected.

9. The computing device of claim 1, wherein the currently-displayed user interface is an interface of a web browser and each page is a particular webpage displayed by the web browser.

10. A non-transitory machine-readable storage medium encoded with instructions executable by a processor of a computing device for gesture-based page navigation, the machine-readable storage medium comprising:
instructions for detecting a held user input and a movement of the held input in a first direction;
instructions for displaying a visual indicator that indicates that a currently-displayed user interface will change from a current page to a previous page in response to a release of the held input, wherein the indicator is displayed while the held input exceeds a first movement threshold in the first direction; and
instructions for modifying the currently-displayed interface from the current page to the previous page in response to the release of the held input while the visual indicator is displayed.

11. The machine-readable storage medium of claim 10, further comprising:
instructions for displaying a second visual indicator that indicates that the currently-displayed user interface will change from the current page to a subsequent page in response to the release of the held input, wherein the second visual indicator is displayed while the held input exceeds a second movement threshold in a second direction that is opposite the first direction.

12. The machine-readable storage medium of claim 11, wherein the subsequent page is a page recommended for a user of the computing device, wherein the recommended page is selected based on content of the current page.

13. A method for enabling gesture-based page navigation on a computing device, the method comprising:
detecting, by the computing device, a held user input and a movement of the held input in a first direction;
displaying a plurality of icons each corresponding to a page of an application, the icons including a first icon corresponding to a current page of an application and at least one additional icon, wherein each additional icon corresponds to an additional page of the application;
displaying a respective visual feature that emphasizes a respective icon of the plurality of icons in response to the held input exceeding a corresponding movement threshold in the first direction; and
setting a currently-displayed interface of the application to a page corresponding to the respective icon in response to a release of the held input while the respective visual feature is displayed.

14. The method of claim 13, further comprising:
displaying a home icon corresponding to a home page of the application;
displaying a home visual feature that emphasizes the home icon in response to the held input exceeding an additional movement threshold in the first direction; and
modifying the currently-displayed interface of the application to the home page in response to release of the held input while the home visual feature is displayed.

15. The method of claim 14, wherein each movement threshold is defined as a predetermined percentage of a dimension of the interface along the first direction.
